(19) United States
(12) Patent Application Publication
(10) Pub. No.: US 2025/0266529 A1
(43) Pub. Date: Aug. 21, 2025

(54) BATTERY PACK

(71) Applicant: ISUZU MOTORS LIMITED, Yokohama-shi (JP)

(72) Inventor: Kenichiro TSUDA, Fujisawa-shi (JP)

(21) Appl. No.: 19/004,522

(22) Filed: Dec. 30, 2024

(30) Foreign Application Priority Data
Feb. 16, 2024 (JP) 2024-021934

(51) Int. Cl. H01M 10/6569; H01M 10/613; H01M 10/625; H01M 10/643; H01M 10/6551; H01M 50/213

(52) U.S. Cl. CPC H01M 10/6569; H01M 10/613; H01M 10/625; H01M 10/643; H01M 10/6551; H01M 50/213; H01M 2220/20

(57) ABSTRACT

A battery pack includes a plurality of battery cells, a tab that connects the battery cells, and a channel that is formed inside the tab and through which a refrigerant for cooling the battery cell flows.

### CROSS-REFERENCE TO RELATED APPLICATIONS

The present application claims priority to Japanese Patent Applications number 2024-21934, filed on Feb. 16, 2024 contents of which are incorporated herein by reference in their entirety.

### BACKGROUND OF THE INVENTION

The present disclosure relates to a battery pack to which a plurality of battery cells are connected.

Japanese Unexamined Patent Application Publication No. 2019-110003 discloses a battery to which a plurality of cells are electrically connected via a bus bar. A lower case of the battery has a channel through which a refrigerant flows to cool the battery.

However, in the battery described above, the cell cannot be effectively cooled because the lower case with the channel is located away from a connecting portion between the cell, which tends to generate heat, and the busbar. In addition, a space is required for the lower case, which hinders achieving space savings for the battery.

### BRIEF SUMMARY OF THE INVENTION

The present disclosure focuses on this point, and an object thereof is to appropriately cool a cell while achieving space savings for a battery pack.

An aspect of the present disclosure provides a battery pack that includes a plurality of battery cells, a tab that connects the battery cells, and a channel that is formed inside the tab and through which a refrigerant for cooling the battery cell flows.

### BRIEF DESCRIPTION OF THE DRAWINGS

FIG. 1 schematically shows a battery pack 1 according to the first embodiment.

FIG. 2 schematically shows a configuration of the battery pack 1 with fins 26.

FIG. 3 schematically illustrates a position of the fin 26.

FIG. 4 schematically shows the battery pack 1 according to the second embodiment.

FIG. 5 schematically shows an aspect of a flow of a refrigerant in a channel 130.

### DETAILED DESCRIPTION OF THE INVENTION

Hereinafter, the present disclosure will be described through exemplary embodiments of the present disclosure, but the following exemplary embodiments do not limit the disclosure according to the claims, and not all of the combinations of features described in the exemplary embodiments are necessarily essential to the solution means of the disclosure.

### First Embodiment

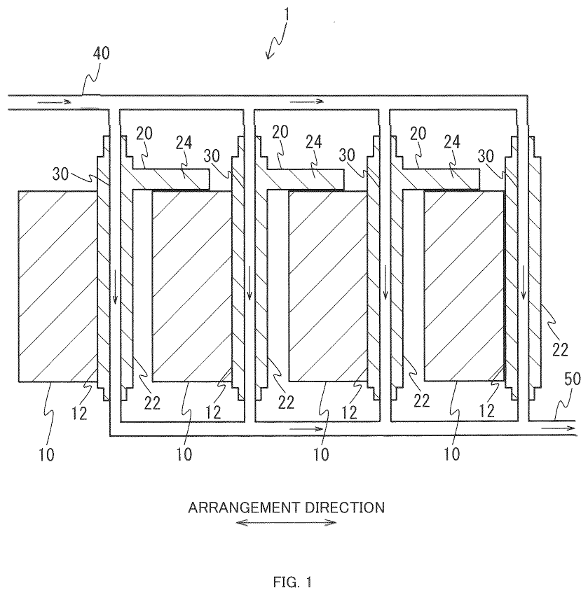

FIG. 1 schematically shows a battery pack 1 according to the first embodiment.

The battery pack 1 has a configuration to which a plurality of battery cells (simply referred to as cells), which are secondary batteries capable of being charged and discharged, are connected. The battery pack 1 is a storage battery mounted on a vehicle, for example. The battery pack 1 includes a plurality of cells 10, a plurality of tabs 20, a channel 30, a first pipe 40, and a second pipe 50.

The plurality of cells 10 are provided at predetermined intervals along the arrangement direction in FIG. 1. The plurality of cells 10 may also be provided at predetermined intervals in a direction orthogonal to the arrangement direction (the depth direction of FIG. 1). Here, the shape of the cell 10 is a cylinder. However, the present disclosure is not limited thereto, and the shape of the cell 10 may be a prism. In the cell 10, the upper surface is a positive electrode, and an outer circumferential surface 12 is a negative electrode.

The plurality of tabs 20 are members connecting the plurality of cells 10. The plurality of tabs 20 are also provided at predetermined intervals along the arrangement direction. Specifically, the tab 20 is provided between the two cells 10 in the arrangement direction. The tab 20 connects a) the outer circumferential surface 12 which is the negative electrode of one cell 10 and b) the upper surface which is the positive electrode of a cell 10 adjacent to the one cell 10. As shown in FIG. 1, the tab 20 includes a shaft portion 22 and an extending portion 24. In the present embodiment, the shaft portion 22 corresponds to a main body of the tab 20.

The shaft portion 22 is located parallel to the cylindrical cell 10. A circumferential surface of the shaft portion 22 is in contact with the negative electrode formed on the outer circumferential surface 12 of the cell 10. For example, the circumferential surface of the shaft portion 22 is in contact with the outer circumferential surface 12 of the cell 10 from one axial end to the other axial end. The diameter of the shaft portion 22 is smaller than the diameter of the cell 10. On the other hand, the axial length of the shaft portion 22 is larger than the axial length of the cell 10. Specifically, the shaft portion 22 extends outward beyond both axial end portions of the cell 10.

The extending portion 24 extends from the upper end portion of the shaft portion 22 in a direction orthogonal to the axial direction. The extending portion 24 is located above the upper surface of the cell 10. The extending portion 24 is in contact with the positive electrode formed on the upper surface of the cell 10. Specifically, the extending portion 24 is in contact with the central portion of the upper surface of the cell 10. The shape of the extending portion 24 in a plan view is rectangular, but is not limited thereto.

The channel 30 is formed inside the tab 20, and is a portion through which a refrigerant for cooling the cell 10 flows. As indicated by arrows in FIG. 1, the refrigerant flows from an upper portion (one axial end portion) to a lower portion (the other axial end portion) of the channel 30. The upper portion of the channel 30 is connected to the first pipe 40, and the lower portion of the channel 30 is connected to the second pipe 50. Therefore, the refrigerant flows into the channel 30 from the first pipe 40, and flows out from the channel 30 to the second pipe 50.

The channel 30 is formed inside the shaft portion 22 of the tab 20 in contact with the outer circumferential surface 12 of the cell 10. In other words, the channel 30 is formed around a connecting portion between the cell 10, which tends to concentrate current and generate heat, and the shaft portion 22. Thus, the outer circumferential surface 12 of the cell 10 is cooled by the refrigerant flowing through the channel 30 in the shaft portion 22. The channel 30 is formed along the axial direction at a central portion of the shaft portion 22. The diameter of the channel 30 is ⅓ to ½ of the diameter of the shaft portion, for example, but is not limited thereto.

The channel 30 penetrates the shaft portion 22, and is formed in the shaft portion 22 from one axial end to the other axial end. In other words, the channel 30 is formed from one axial end portion to the other axial end portion of the cell 10. Accordingly, the refrigerant flowing through the channel 30 can cool a wide area of the outer circumferential surface 12 of the cell 10.

The first pipe 40 is a channel through which the refrigerant flows toward the channel 30. The first pipe 40 functions as a supply channel for supplying the refrigerant to each of the channels 30 formed inside the plurality of tabs 20. The refrigerant flowing through the first pipe 40 has an insulating property. The first pipe 40 is provided with a pump that pressure-feeds the refrigerant, for example, and the refrigerant can be constantly supplied to the channel 30.

The second pipe 50 is a channel through which the refrigerant flowing out from the channel 30 of each tab 20 flows. The second pipe 50 is connected to the first pipe 40, and forms, together with the first pipe 40, a circulation channel through which the refrigerant circulates. The circulation channel is provided with a heat exchanger that cools the refrigerant. The heat exchanger may cool the refrigerant with air or may cool the refrigerant with a cooler refrigerant. Accordingly, the refrigerant cooled by the heat exchanger flows through the channel 30, and thus the low-temperature refrigerant can cool the cell 10 via the channel 30.

The tab 20 may have a fin 26 to improve the efficiency of cooling the cell 10.

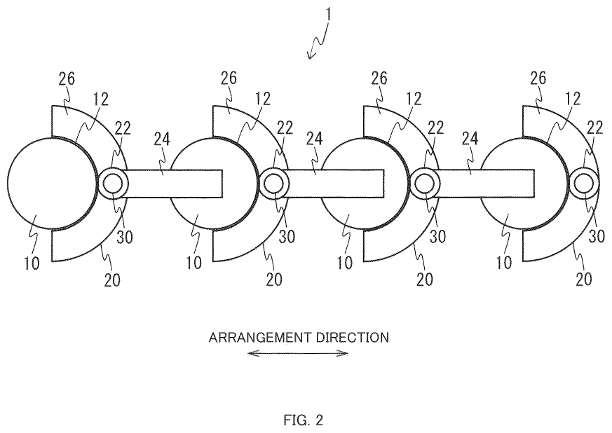

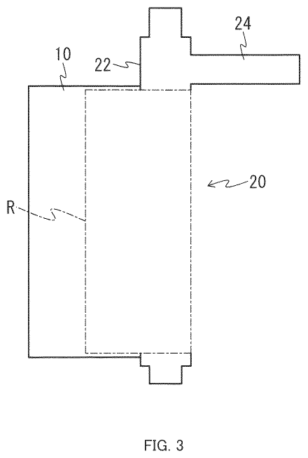

FIG. 2 schematically shows a configuration of the battery pack 1 with the fins 26. FIG. 3 schematically illustrates a position of the fin 26. A region R indicated by a chain line in FIG. 3 is a position where the fin 26 is provided.

As shown in FIG. 2, the fins 26 are respectively provided to the cells 10, but the configuration of the fin 26 of each cell 10 is the same. Therefore, the configuration of one fin 26 will be described below.

The fins 26 are formed in a plate shape, for example, and are provided in plural at predetermined intervals in the axial direction within the region R shown in FIG. 3. As shown in FIG. 2, each of the plurality of fins 26 is in contact with the outer circumferential surface 12 of the cell 10. Specifically, the fin 26 is in contact with the outer circumferential surface 12 of the cell 10 along the circumferential direction of the cell 10. This facilitates the conduction of heat from the cell 10 to the fin 26, thereby facilitating more effective cooling of the cell 10.

As shown in FIG. 2, the fin 26 extends from the shaft portion 22 of the tab 20. Specifically, the fin 26 extends from the shaft portion 22 along the outer circumferential surface 12 of the cell 10 with a predetermined curvature. The width of the fin 26 is constant here, but it is not limited thereto. This facilitates the heat conducted from the cell 10 to the fin 26 to be cooled by the refrigerant flowing through the channel 30.

Here, as shown in FIG. 2, the fin 26 covers half of the outer circumferential surface 12 of the cell 10, but it is not limited thereto, and may cover the entire outer circumferential surface 12 of the cell 10. In this way, it is desirable that the fin 26 covers at least half of the outer circumferential surface 12 of the cell 10. Further, as shown in FIG. 3, the fin 26 is provided from one axial end portion to the other axial end portion of the cell 10. Providing the fin 26 with the above-described configuration enables the fin 26 to come into contact with a wide area of the outer circumferential surface 12 of the cell 10, thereby facilitating more effective cooling of the cell 10.

### Second Embodiment

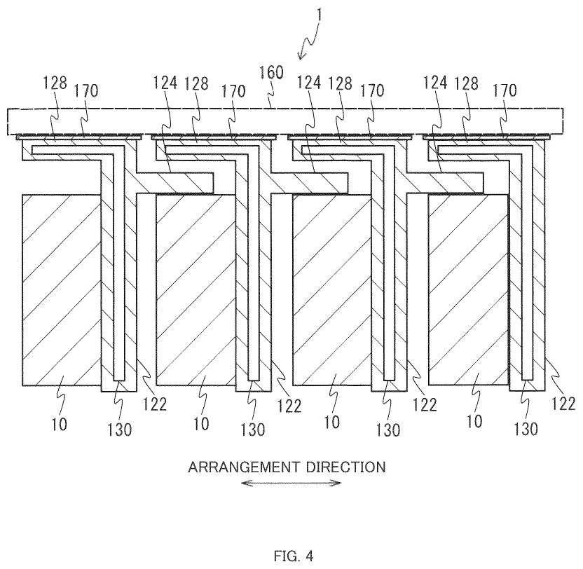

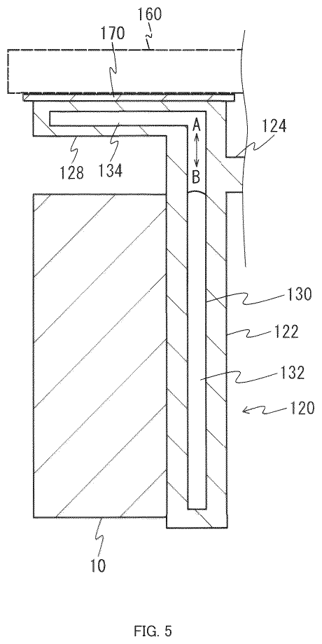

A configuration of the battery pack 1 according to the second embodiment will be described with reference to FIGS. 4 and 5.

FIG. 4 schematically shows the battery pack 1 according to the second embodiment. FIG. 5 schematically shows an aspect a flow of the refrigerant in the channel 130.

In the first embodiment described above, the channel 30 formed in the tab 20 connects the first pipe 40 and the second pipe 50 provided outside the tab 20, the refrigerant flows into the channel 30 from the first pipe 40, and the refrigerant in the channel 30 flows out to the second pipe 50. In contrast, the channel 130 of the second embodiment is closed off by the tab 120, allowing no additional refrigerant to flow into the channel 130. Detailed configurations of the tab 120 and the channel 130 will be described below.

As shown in FIG. 5, the tab 120 includes a shaft portion 122, a first extending portion 124, and a second extending portion 128. The shaft portion 122 and the first extending portion 124 have the same configuration as the shaft portion 22 and the extending portion 24 described above. The second extending portion 128 extends from the upper end portion of the shaft portion 122 in a direction orthogonal to the axial direction. The extending direction of the second extending portion 128 is opposite to the extending direction of the first extending portion 124.

As shown in FIG. 4, the channel 130 is formed in the shaft portion 122 and the second extending portion 128. The channel 130 is formed in an L-shape along the shapes of the shaft portion 122 and the second extending portion 128. The refrigerant in the channel 130 is non-insulating. The channel 130 is closed off by the end portions of the shaft portion 122 and the second extending portion 128. Accordingly, it is possible to prevent the surrounding members from being damaged by electric leakage through the refrigerant.

As shown in FIG. 5, the channel 130 includes a first accommodation section 132 and a second accommodation section 134.

The first accommodation section 132 is located at the same position as the outer circumferential surface 12 of the cell 10 in the up-down direction. The first accommodation section 132 is provided parallel to the outer circumferential surface 12 of the cell 10. The first accommodation section 132 accommodates a liquid refrigerant. When cooling the outer circumferential surface 12 of the cell 10, a portion of the refrigerant in the first accommodation section 132 is vaporized (evaporated) by the heat of the cell 10.

As shown in FIG. 5, the second accommodation section 134 is provided above the cell 10. Specifically, the second accommodation section 134 is located directly above the upper surface of the cell 10. The second accommodation section 134 communicates with the first accommodation section 132, and is orthogonal to the first accommodation section 132. The second accommodation section 134 accommodates the refrigerant vaporized in the first accommodation section 132.

As shown in FIG. 4, the battery pack 1 of the second embodiment includes a heat exchanger 160 for cooling a gaseous refrigerant in the second accommodation section 134. The heat exchanger 160 is provided so as to face the second accommodation section 134. Specifically, the heat exchanger 160 is located above the second extending portion 128 in which the second accommodation section 134 is formed. An insulating member 170 is interposed between the heat exchanger 160 and the second extending portion 128.

A refrigerant having a temperature lower than that of the refrigerant in the second accommodation section 134 flows inside the heat exchanger 160, and the refrigerant in the second accommodation section 134 is cooled by that refrigerant. The refrigerant in the second accommodation section 134 is condensed and liquefied upon cooling. The liquefied refrigerant moves to the first accommodation section 132 located below the second accommodation section 134.

It should be noted that, in FIG. 4, one heat exchanger 160 faces four tabs 120, but it is not limited thereto. For example, the heat exchanger 160 may be provided for each tab 120.

In the second embodiment, the refrigerant in the channel 130 flows between the first accommodation section 132 and the second accommodation section 134 as follows.

Specifically, the liquid refrigerant in the first accommodation section 132 is vaporized by the heat when cooling the cell 10. Then, the vaporized gaseous refrigerant moves to the second accommodation section 134 located above the first accommodation section 132 (specifically, the refrigerant moves in the direction indicated by an arrow A in FIG. 5). The gaseous refrigerant that has moved to the second accommodation section 134 is condensed by being cooled by the heat exchanger 160. Then, the condensed liquid refrigerant moves to the first accommodation section 132 located below the second accommodation section 134 (specifically, the refrigerant moves in a direction indicated by an arrow B in FIG. 5).

As described above, the refrigerant continues to flow between the first accommodation section 132 and the second accommodation section 134 by alternately repeating vaporization and condensation in the channel 130. As a result, the temperature of the refrigerant accommodated in the first accommodation section 132 located at the same position as the outer circumferential surface 12 of the cell 10 can be maintained at a low temperature, and so even without the need for a new supply of refrigerant to the channel 130 from the outside, cooling of the cell 10 can continue.

### Effects of Embodiments

The battery pack 1 of the above-described embodiment includes the tab 20 connecting the plurality of cells 10. The channel 30 through which the refrigerant for cooling the cell 10 flows is formed inside the tab 20.

Accordingly, the channel 30 formed in the tab 20 connecting the cells 10 can effectively cool the cells 10. In particular, the channel 30 is provided around the connection portion between the cell 10, which tends to concentrate current and generate heat, and the tab 20, thereby cooling the cell 10 more effectively. In addition, since the channel 30 is formed in the tab 20, there is no need to provide additional space for installing a cooling structure to cool the cell 10. As a result, it is possible to appropriately cool the cells while achieving space savings for the battery pack 1.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments of the present disclosure. Further, effects of the new exemplary embodiments brought by the combinations also have the effects of the original exemplary embodiments.

1. A battery pack comprising:
a plurality of battery cells;
a tab that connects the battery cells; and
a channel that is formed inside the tab and through which a refrigerant for cooling the battery cell flows.

2. The battery pack according to claim 1, wherein
the channel is formed inside the tab in contact with an outer circumferential surface of the battery cell.

3. The battery pack according to claim 2, wherein
the channel is formed from one axial end portion to the other axial end portion of the battery cell.

4. The battery pack according to claim 2, wherein
the tab includes:
a main body in which the channel is formed, and
a fin extending from the main body and is in contact with the outer circumferential surface.

5. The battery pack according to claim 4, wherein
the fin covers at least half of the outer circumferential surface.

6. The battery pack according to claim 4, wherein
the fins are provided in plural at predetermined intervals in the axial direction of the battery cell.

7. The battery pack according to claim 1, further comprising:
a supply pipe that supplies the refrigerant having an insulation property to each of the channels formed inside the plurality of tabs.

8. The battery pack according to claim 1, wherein
the refrigerant is non-insulating, and
both ends of the channel are closed off by the tab.

9. The battery pack according to claim 8, wherein
the channel includes:
a first accommodation section that is located at the same position as the outer circumferential surface of the battery cell in the up-down direction and accommodates the liquid refrigerant, and
a second accommodation section that is provided above the battery cell and communicates with the first accommodation section, wherein
the second accommodation section accommodates the refrigerant that has been vaporized in the first accommodation section.

10. The battery pack according to claim 9, further comprising:
a heat exchanger that is provided to face the second accommodation section and cools the refrigerant accommodated in the second accommodation section.
